(19) United States
(12) Patent Application Publication
(10) Pub. No.: US 2008/0091403 A1
(43) Pub. Date: Apr. 17, 2008

(54) Large Training System Simulation Using Dynamic Network Entities

(76) Inventors: Gregory A. Harrison, Oviedo, FL (US); Lorie R. Ingraham, Orlando, FL (US); Darryl L. Easler, Orlando, FL (US)

Correspondence Address: WELSH & KATZ, LTD, 120 S RIVERSIDE PLAZA, 22ND FLOOR, CHICAGO, IL, 60606, US

(21) Appl. No.: 11/549,810

(22) Filed: Oct. 16, 2006

(51) Int. Cl. G06F 17/50

(52) U.S. Cl. 703/17

(57) ABSTRACT

A multi-processor synchronized simulation system that incorporates a common control element which generates common start frame messages for the various simulating systems. A start frame message will not be transmitted by the control element until all entity data from a prior frame has been sent to the appropriate simulation system. Each respective system, in response to the start frame message, then executes its next interval of frame processing and issues a frame complete message to the control element. The element in turn issues a subsequent start frame message only when all of the simulation systems have provided a respective frame complete message.

### FIELD

The invention pertains to systems and methods for parallel discrete event simulation. More particularly, the invention pertains to such systems and methods which incorporate a plurality of synchronized simulation sites.

### BACKGROUND

In simulation, it is important to distinguish between actual, wall-clock, time that is occurring in physical reality (real time), versus simulator time. In a continuous-time simulation, the simulator time will move forward smoothly at evenly-spaced small intervals of time, thus supporting mathematical functions such as differential equations that are time-based. Continuous simulators may run faster than real-time or slower than real-time.

An event is something that occurs at a certain instant in time. There may be rules that indicate that when a certain event occurs, then other events must be scheduled to occur at some time in the future. Since a discrete-event simulator keeps track of what events are coming up, after it completes an event, it can jump through simulated time to immediately process the next event, even though the next event may be weeks later in simulated time.

Processing of events in a discrete-event simulator tends to be performed very rapidly, since the simulator can skip all the time periods between events. So, if portions of the same simulation are being run in different simulator processors, it is very possible for one simulator to move further ahead in time than another. Two common distributed discrete-event synchronization protocols are the conservative Chandry-Misra synchronization protocol by Chandy and Misra, see “Distributed Discrete-Event Simulation”, Misra J. 1986, ACM Computing Surveys 18, No. 1 (March) 39-65, and the optimistic protocol.

The Chandry-Misra approach avoids casualty errors by using sequenced event time stamps to then process events with the smallest time stamp if the process can guarantee that it will not subsequently receive an event with a smaller time stamp. This conservative method is limited by the time it takes to look ahead to predict the “safety” of the incoming event.

One serious problem with conservative simulations is the possibility of deadlocks. To resolve this issue, deadlock resolution schemes have been developed like deadlock avoidance via null messaging and deadlock detection and recovery, which adds to the complexity of this type of distributed simulation solution.

Such mechanisms are known to those of skill in the art as “time-warp”. In this circumstance, an error is assumed to have occurred when an event which has an earlier time associated with it is received at one of the simulators. In known systems which use this approach the appearance of such an erroneous event triggers implementation of one or more roll back processes or algorithms. These processes or algorithms attempt to reverse the effects throughout the system of simulators relative to all events that have been processed prematurely relative to the newly emergent early event. This processing in turn may well be able to correct an erroneous sequence of events but it carries its own price. In this instance, additional processing, an overhead time, is required to address the erroneous condition of one or more simulators in the system.

Probably the best known optimistic mechanism for distributed discrete simulation is the Time Warp. Using this scheme, a casualty error occurs when an event with a smaller time stamp than one that has been already processed is received which triggers a process commonly known as rollback. Thus, the need for rollback occurs when the simulation executing in one simulator (Simulator A) may produce events that may affect the simulation that is executing in another simulator (Simulator B). Simulator A sends a message to Simulator B informing Simulator B that an event has occurred in Simulator A at time T1. Then, Simulator B has to “undo” everything it did in the simulation since simulated time T1, add in the new event from Simulator A, and reprocess its simulation from time T1.

Time warp mechanisms can be an extremely costly in memory, network bandwidth, and processing time. Some mechanisms and processing environments can speed it up, but it still involves deleting outcomes that were already executed, and starting over from an earlier simulated time. In large simulations, this process can be a significant drawback since it could lead to a thrashing behavior. To correct time warp rollback pitfalls, newer approaches have been developed to improve optimistic simulation, such as virtual time stamps, optimistic self-adaptive time windows, breathing time buckets (BTB), and breathing time warp mechanisms. Although these mechanisms do improve the efficiency of rollback procedure, the complexity and communication overhead cost of the rollback still exists.

Previous related work by others in this field involves the creation of software development environments that support the creation of distributed discrete-event simulations in object-oriented software languages such as C++ and Java. These simulations run on either parallel processors within a single computer or on separate networked computers. Many of these approaches require all simulation players to use the same programming language and shared libraries. This limits the type of simulations that can join the distributed simulation.

There thus continues to be a need for systems and methods which implement parallel simulations while avoiding difficulties of a type as described above. For example, it would be desirable to be able to eliminate processing time and resources required to implement the so called “time-warp” and/or rollback processing. It would also be desirable to be able to easily add a simulation site so as to increase the size of the system being simulated. Further, it would be desirable to enable the various simulation systems or sites to communicate directly with one another while the simulation process is ongoing.

### BRIEF DESCRIPTION OF THE DRAWING

FIG. 1 is a block diagram of multiple simulators and a simulator controller embedded in a network in accordance with the invention;

FIG. 2 is a block diagram of a single simulator embedded inside a multicast network, with dynamic networked entities moving through the system;

FIG. 3 is a diagram of the timing and order of processing, and, handshaking between two simulators and a controller;

FIG. 4 is a flow diagram of a simulator initialization process;

FIG. 5 is a flow diagram that illustrates how dynamic network entities move through the simulators; and

FIG. 6 is a state diagram that illustrates aspects of operation of a system controller in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

An architecture which embodies the invention passes entity objects between computers in a discrete simulation to overcome computational limitations that result from the use of networked independent discrete event simulations.

The receipt of the entity from one simulation triggers events in another simulation. This methodology enables a distributed simulation approach which not only enhances scalability, but also enables independently functioning simulations to communicate with and affect the outcome of each other in a synchronized manner.

In one aspect of the invention the execution of the simulation on the multiple simulators is controlled externally with a synchronization handshake mechanism.

A participating simulation player need only adhere to predetermined network data formats and message send/receive protocols. As a result new players, with internally different structures can readily be added to the network.

In another aspect of the invention, synchronized multi-processor discrete-event simulation communication of entity or event data takes place over a network. Two types of messaging: entity data messages and processor synchronization messages can be sent. The receipt and issuance of synchronization messages keeps the different processors in time step with each other. The receipt of entity data from one simulation triggers events in another simulation. In accordance with the invention, this distributed simulation approach not only enhances scalability, but also enables specialized simulations to communicate and affect the outcome of each other while maintaining time integrity.

Embodiments of the invention can be applied to the simulation of a schoolhouse training system, but could equally be applied to the simulation of other operational systems, such as a manufacturing or transportation system. The present method can be use to simulate other complex systems without limitation.

Different discrete-event simulations can be coupled together in a distributed multi-processor environment by entity or event transfer and message synchronization via network packets. The approach is time-interval based and uses one of the processors to host a main controller node. Simulation processor nodes execute independently, export entities via network packets, and “report” via network packets that they have completed the established time interval.

The simulation may be partitioned into multiple simulators for many reasons, such as to better represent the real system being simulated or for computer resource usage. In some cases, the actual system includes networked machines in different buildings. The entities are work items being sent from machine to machine. In other cases, the simulation software does not support a large enough system, or the processing time would have been prohibitive if all the simulation capabilities were implemented in one computer.

An exemplary entity/event data format is depicted in Table 1. Each entity or event is packaged by the issuing simulator with a unique ID, a type specification, and a variable number of attributes. Note that although a timestamp filed is provided, the present methodology does not use this field for synchronization. It can be used by any simulation requiring this information.

TABLE 1
Entity/Event Message Packet.

Unique Entity or Event ID
Entity or Event Type
Message Simulation Time Stamp
Attribute 1
Attribute 1
Attribute 1
. . .
Attribute N

Synchronization is maintained by network packets (e.g., UDP packets) that indicate it is time to simulate the next time interval. Time intervals can be configurable to be by minute, hour, day or week, or some other time period appropriate to the system being simulated. These intervals can be of higher or lower fidelity depending on the nature of the simulations.

In accordance herewith, client-server communications from a controller are used to configure and initialize the simulations players. The main controller also manages the receipt and issuing of all synchronization messages which are sent via broadcast messages to all simulations. After all players report that they have completed the current time interval, they are given the “go ahead” by the main controller to start the next time interval.

When each simulator player receives the start frame message all entity data from the simulation must have been sent to the appropriate simulation player. As each simulation player reads packets from the port, the packets are stored in the player's process queue in time order. The player proceeds to execute its next interval frame processing, issues its Frame Complete message, and waits for the start of the next frame.

This type of timing scheme is advantageous in that it avoids the need for time-costly prediction “Time Warp” or rollback algorithms. Deadlock situations are also avoided because all messages are received in the same time interval.

Each participating simulator starts its simulation at the same simulated time, Ts, and runs only for the simulated time specified by P. At time Ts+P, the simulator stops processing, and sends a message to a central controller that says that it has completed its time frame processing.

While it was processing, and/or at the completion of its processing period, P, the simulator may have been sending entity packets and other information to other simulators that are participating in the distributed simulation. In a method which embodies the present invention, unlike in the rollback method, all the other simulators will delay processing this information until the start of the next period.

Deadlock and rollback issues are avoided by never letting any simulation proceed further into the future than any other simulation. There is a predetermined duration (time frame) into the future during which each simulation can execute before it must stop and wait for all the other associated simulations to catch up. Thus, there is a discretization of time that limits the processing of the simulations into a maximum duration, P, during which time, no simulation will affect the processing of another simulation.

Network messaging bandwidth is efficiently used since there is no need to transmit cancellation messages or null “anti-deadlock” messages as employed by other distributed discrete-event methods. Network transmissions are dedicated towards moving the simulation execution forward in time.

In yet another aspect of the invention, independent discrete-event simulations do not need to be written in any particular programming language. The independent simulations only have to adhere to pre-defined network entity/event data formats and network message send/receive protocols. Synchronization is managed by an external Controller module.

Entities/Events may queue up at the entrance to the other simulators, but will not affect the other simulators during the current period. Those of skill in the art will understand that the period, P, needs to be determined so as to get proper simulation of the system. P may take on time periods of microseconds to months, or whatever is appropriate for the simulation at hand, just so that the underlying system being simulated does not change too much during that time, as determined by a systems analysis of the actual system to be simulated.

When all simulators have transmitted the ‘done with current period’ signal to the main controller, the main controller will issue the ‘start’ signal to all the simulators. The distributed simulators will then read in and process the new information that had arrived, and process another period of simulation, stopping again, after a simulated time period P has elapsed.

Embodiments of the invention establish a synchronized networking framework for simulators, enabling the rapid extension of the functionality of existing simulators, and reducing the time required to run an extensive simulation.

In a disclosed embodiment, entities are transmitted instead of events, although events could also be transmitted. Known discrete simulations transmit events that may cause roll-back to be required in other co-simulations to account for events occurring in other co-simulations. Embodiments of the invention require no rollbacks. The processing time is discretized to plurality of steps and the entities are collected in prior to commencing the next processing period.

No entity proxies are required in order to represent entities being worked on at other simulators, since the entity can only exist in one simulator at a time.

Embodiments of the present method provide substantial scalability potential. For example, in an implementation using common desktop computers and computer networks, overall system computing power can be raised by the addition of more computers to the network, thus avoiding the requirement to modify the performance of any one of the simulators already coupled to the network.

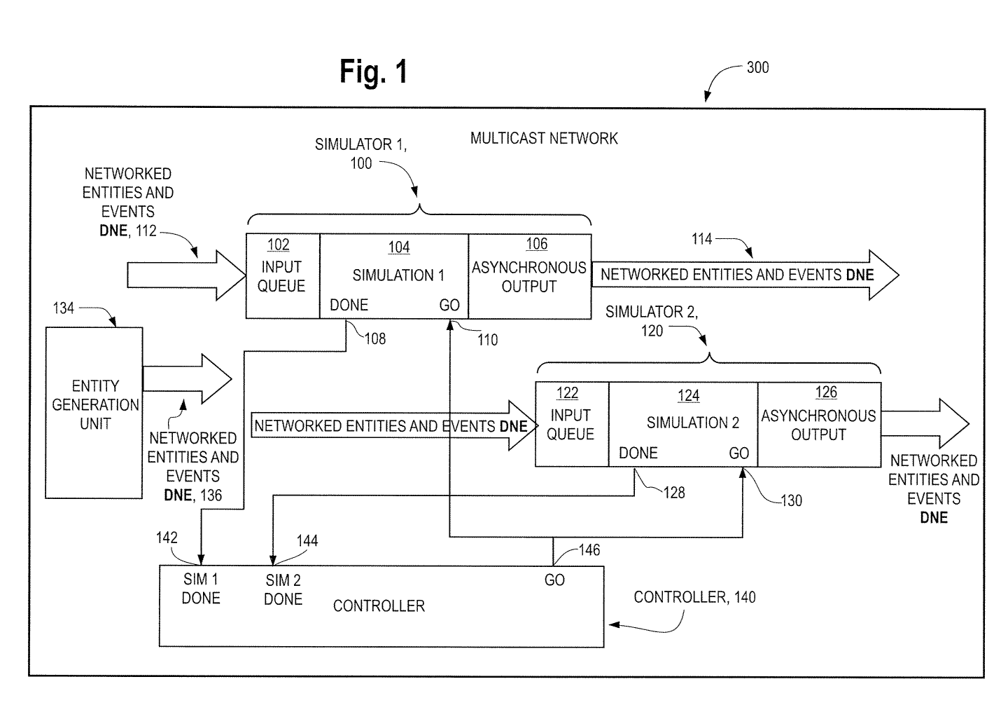

FIG. 1 illustrates multiple simulators, 100, 120, in a distributed networked simulation, as well as the control of the entire simulation by Controller 140. The simulators 100, 120 receive data from and send data to one another via a network. Neither network details nor the number of simulators on the network are limitations of the invention. Illustrating two simulators 100, 120 in FIG. 1 is exemplary only. Embodiments of the present system and method could include dozens of simulators without limitation.

Dynamic Networked entities/events (DNEs) 112 and 114 enter and leave the individual simulators, and wait in the Input Queues 102 and 122 until a Go command is received 110 and 130 at which time they enter into the Simulations, 104 and 124 for processing. When the DNEs have been processed in the respective simulations they leave asynchronously 106 and 126, and proceed to the next simulation as ordered by a processing schedule, to wait in the appropriate queue until the next time period of processing. The overall processing is conducted in a synchronized manner as controlled by the Controller 140.

There is a separate Done message sent by each simulator, 108, and 128 to the controller 140. Only when all the Done messages have been received 142 and 144 will the Controller 140 issue the Go signal 146 to all the simulators, entering at 110, and 130, to begin simulation for the next time frame. Example implementations of the transmission and reception of the Done and Go signals could involve the use of web services or UDP sockets, if permitted.

The use of multiple simulators allows entity pipelines to be realized to govern a large scale flow of entities through different simulators or processes sharing the same system. While multiple entities may share the entry point for a given process, the entities leaving that process do not necessarily have to go to a shared “next process”. This dynamic characteristic of the entity representation allows different plumbing of entity paths through the simulations. The “next location” of an entity may also be changed in a given simulation, if, for instance, the simulation flags the entity as defective, it can change the next address to be a waste heap, or if the quality is exemplary, it can go to an advanced processing location, as in a faster measured time spec on a microprocessor chip entity.

For the overall simulation the entry of different types of entities into the system can be controlled with an Entity Generation Unit 134. Unit 134 time-sequences when entities enter, what types of entities that they are, what processing pipelines they go to, and where their first simulator is to be. The entity generation unit, 134 can be implemented on a separate computer, as long as it has access to the network on which the processing is occurring. The Entity Generation Unit 134 sends DNEs 136 into the system, to their appropriate simulator destinations. These DNEs travel through the network in the same manner as DNEs that leave the simulators after processing.

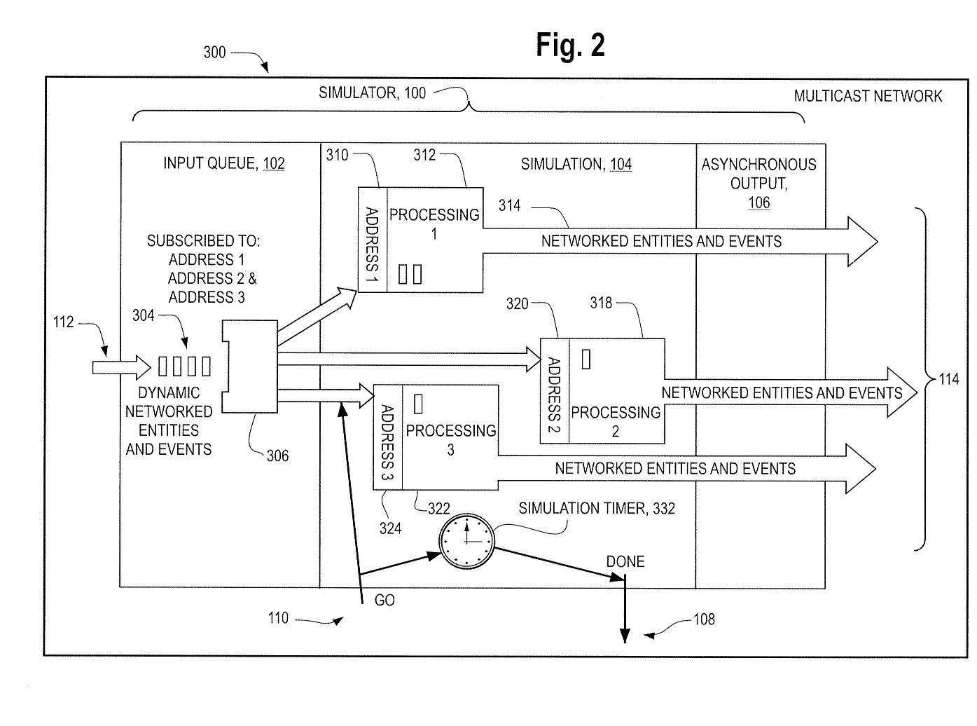

FIG. 2 illustrates the Simulator 100 residing in a network environment 300. In one realization of the system, the network 300 can be implemented as a multicast local area network (LAN). The multicast network can be used to provide automatic hardware acceleration for the routing of the entities and events through the entire multi-simulator system. This automation is achieved because multicast networking uses the concept of subscribing to multicast groups, and then receiving the information that is sent to that group.

In the case of a simulator, each process or processor, 312, 318, 322 can be given a multicast address 310, 320, 324 and it subscribes on the multicast network to receive all data traffic intended for that address. When a given process has events or entities to send to another simulator, the entity or event information is packaged into a multicast message and transmitted to the receiving process's multicast address. The system does not need to know in what processor the destination simulator process resides. Multicast Ethernet-based processing will automatically cause the entity or event packet to reach the simulator process correctly.

Simulator 100, in the case of FIG. 2, supports three processes or processors 312, 318, and 322. Each process or processor has its own multicast address 310, 320, and 324. The Simulator 100 subscribes to each of the multicast groups 310, 320, and 324, so that entities in the network that are sent to any of these groups 112 are directed into this simulator as dynamic networked entities/events (DNE) 304. The DNEs 304 are captured and held in a queue 306 until the Go signal 110 releases them all into the Simulation section 104, where they are distributed to the end processes 312, 318, and 322 defined by the addresses held by each DNE.

During processing, the information that the DNE contains may be altered, thus indicating the dynamic nature of the DNE. The DNE would then be given the address of the next process to enter in the system simulation, and this may even be a terminal process where the DNE exits the system, such as a finished manufactured product, for example. If more processes must process the DNE, then the multicast address of the next process is coded into the DNE multicast representation of the entity or event and it is sent out onto the network 314, 106, 114 for further processing.

Simulator 100 also includes a Simulation Timer 332, to measure how long to conduct the execution of the processes simulated in simulator 100. There is a common, pre-determined, time duration or interval that all simulators in the networked simulation will use in conjunction with their internal simulation timers.

When the Go command 110 is received at the simulator, all the DNEs received to that point will enter the Simulation 104. Until the duration is complete, the simulation will execute, sending DNE packets when they become ready for issue. Once the end of the simulation interval has been reached, all simulation execution in this simulator will stop, and the Done signal 108 will be transmitted from Simulator 100.

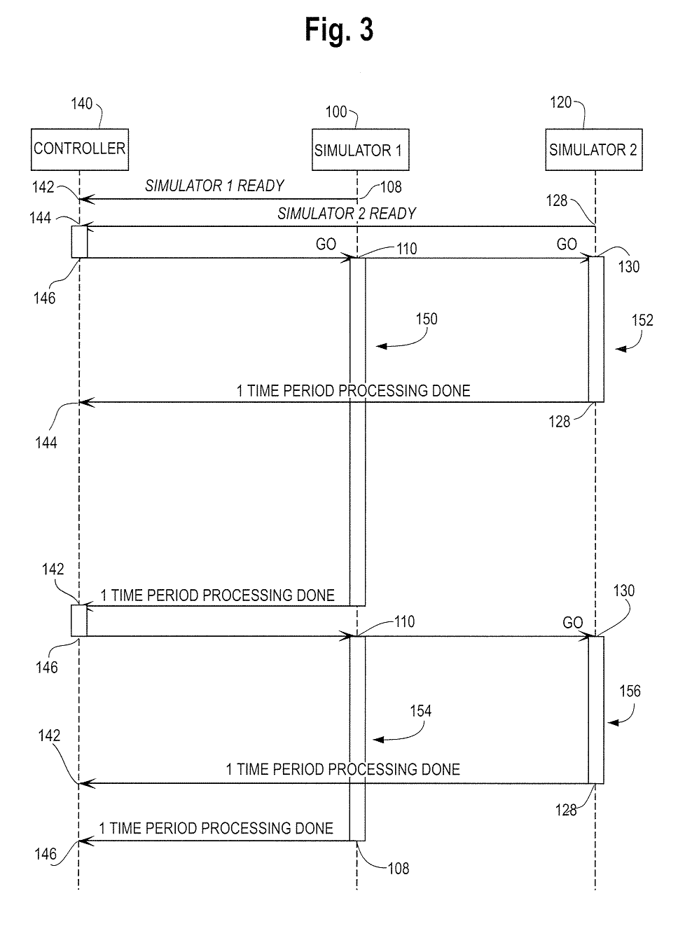

FIG. 3 is a diagram that illustrates the control and handshaking between multiple simulators such as 100, 120, and the Controller 140. In FIG. 3, two simulators, 100 and 120 are communicating with Controller 140. Each of the dashed vertical lines in this diagram is a lifeline for the controller or a simulator. The numbering for the signals corresponds to the previous figures.

The process starts with Simulator 1 issuing the Simulator 1 Ready signal 108 to the controller input 142 indicating that it has completed initialization and is ready to participate in the simulation. The Controller 140 is set to expect both Simulator 1 and Simulator 2 to participate in the simulation. Therefore, the Controller waits until Simulator 2 sends its Simulator Ready signal 128 to the Controller input 144 before it issues the Go command 146 to the multiple simulators inputs 110, 130.

After receiving the Go commands, both simulators begin processing their simulations, for the pre-determined simulation time frame duration. The simulation duration is a time frame in simulated time not in real, wall-clock time. For instance, the simulator might be processing 24 simulated hours in one time frame, but in wall-clock time, it may only take 1 minute to perform the processing.

Some simulators may be hosted on faster computers and can execute their simulation time frame faster, as seen in FIG. 3, durations 150, 152 and 154, 156. In this case Simulator 2 (120) is faster than Simulator 1 (100), and the real wall-clock time that it takes to process one simulation time frame 152 is less than what it takes Simulator 1 to process the same simulation time frame 150. All faster simulators will have to wait until the slowest simulator completes its processing before it can run again.

When each simulator has completed its simulation time frame processing, it sends the Done signal 128, 108, to the Controller inputs 144, 142. When the Controller 140 determines that it has received the Done signal from each of the simulators participating in the simulation, then the Controller will issue the next Go signal 146, to all the simulator inputs 110, 130. They each load whatever DNE's they have received as a result the previous simulation period, and process the next simulation period 154 and 156. When the simulation period is complete at each simulator, the respective Done signal, 108 and 128 is sent to the Controller input 144, 142. The processing continues in this manner until the system has reached the maximum simulation time or is stopped in some other manner.

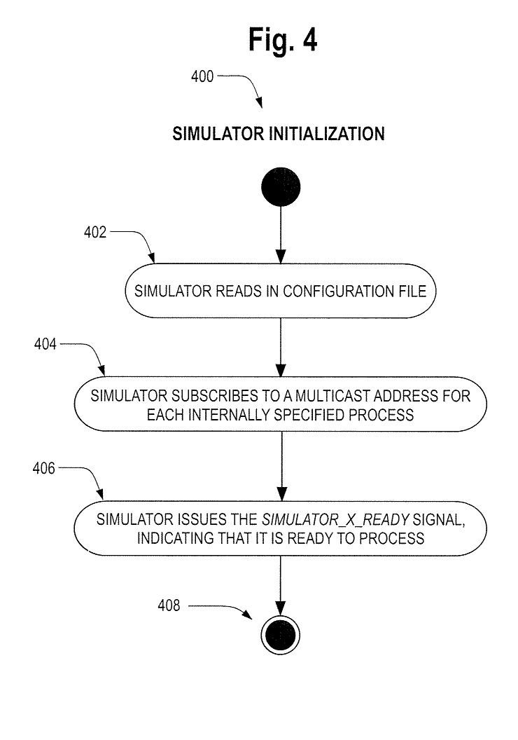

FIG. 4 a flow diagram, illustrates the start up of the system 400 for each simulator, where the simulator reads a locally stored initialization file 402, or is sent initialization data as an XML or custom formatted file via network services. The simulators may also utilize a fixed simulation initialization, but that method sacrifices future flexibility.

When the simulation initialization is complete, the simulator subscribes on the network to each of the addresses or multicast groups it is using for its processes 404. Then the simulator issues the Simulator X Ready signal, 406, to show that it is ready to simulate, and exits to wait for the Go signal 408. The Controller 140 adds the simulator to the list of simulation players at this point, and waits until all needed simulators are online and ready before issuing the Go signal.

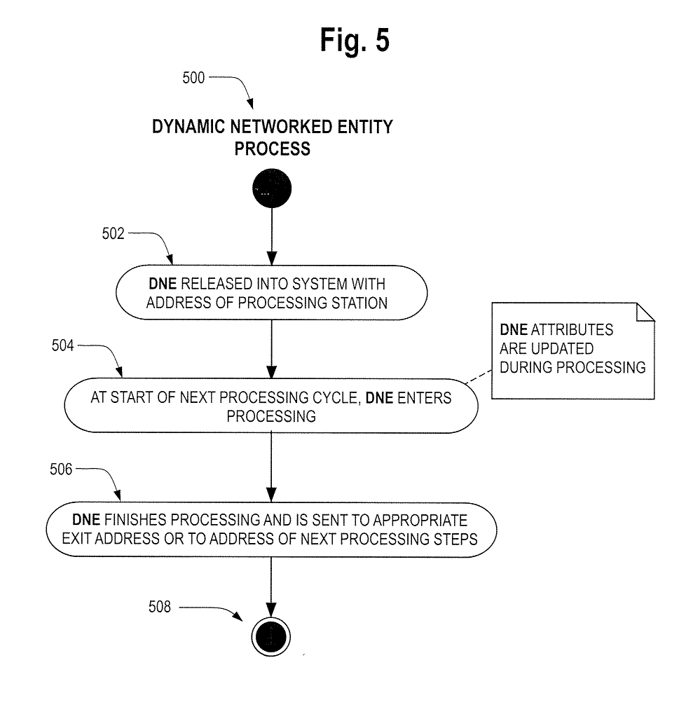

FIG. 5 illustrates the runtime processing 500 of the simulation. Beginning the sequence of processing through the system, DNEs are given a process address to go to a processing station 502. DNEs will accumulate at the input queues of each of the simulators (or processors if the queues are attached directly to the processes instead of being at the front of the simulator).

The DNEs are stored until the Go signal is received from the controller. The Go signal starts the next processing cycle 504. DNEs enter their processes, or processors and have work performed on them. DNEs already in the processes continue being processed. When processing is complete on a DNE 506, the DNE is prepared for transmission to a particular “next address” on the network. The “next address” and the DNE are encoded into a network entity/event message and transmitted.

The entity/event will be stored at its new location until the start of the next processing cycle before processing begins anew on it. Processing continues in the simulator 508 until the end of the current simulation period.

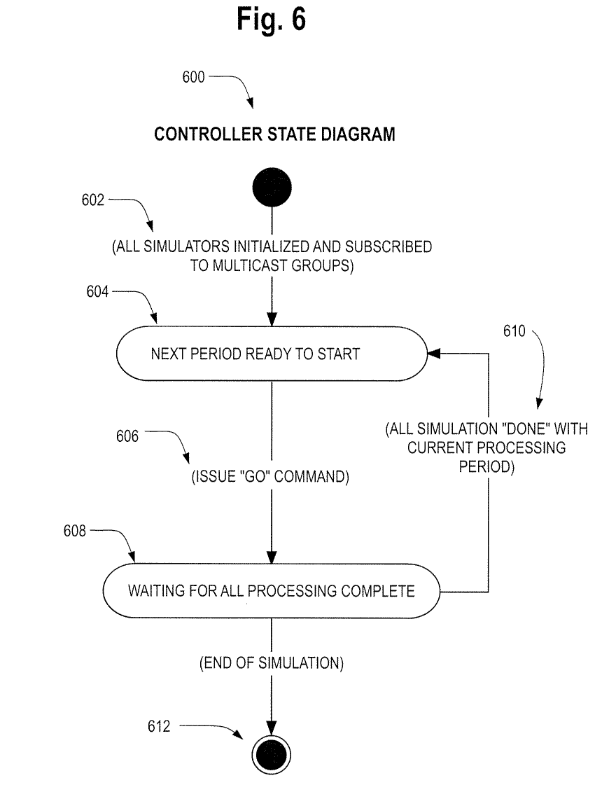

FIG. 6 illustrates operation 600 of the Controller 140. When all simulators have initialized and subscribed to their multicast groups 602, the controller, at the start of the next period 604 issues the next Go command 606. It then waits for processing to complete 608. When all simulators have issued the Done signal 610, the controller state enters Next Period Ready to Start 604. At this time, the controller may collect from the other simulators status information and perform statistics processing or other work, and then it issues the next Go command 606. If the Controller 140 has determined that the entire simulation is complete, then it will stop issuing Go commands 612, and the results may then be analyzed.

All system processing is complete at the end of each simulation period. All transmitted entities/events are sent out on the network system, but do not enter their appropriate destination simulation processes until the start of the next simulation period.

The simulation period P must be made short enough so that the system processes the entities and events in a natural time frame. It may be made as small or as large as desired, based on how quickly the system changes, the nature of the simulations, and how fast the information coming from other simulators must be regarded in the simulation system.

One application of DNE is a multi-site training analysis & design system. In that system, students represent the networked entities. The entities are the DNEs that move from course to course, lesson to lesson, and student pipeline to pipeline, competing with other entities at the training site for training-related resources as they become available.

When a course is simulated at a single location or site, students attending that course will stay confined to simulator running at a single site. When multiple sites are involved, the choices are to update the software simulation to handle multiple sites, or to distribute the effort across multiple computers. In an embodiment of the present invention, a set of networked computers can be used, one for each training site. Each location site and the site's associated resources can be are assigned to a unique networked computer. In order for each instance of the schoolhouse simulation to interact with another, the DNE methodology can be used to synchronize the sites while maintaining the same level of precision and performance achieved when the simulation was implemented in only one computer.

In the training system being simulated, students finishing one training course generally are scheduled to be sent to a follow-on course, often at a different training site. The present method enables students to exit one course and be automatically directed to the entrance queue of another course, whether that course was located at the same site or another site.

In the above-noted training, analysis design system, each networked computer runs its simulation, representing all of the courses with their associated resources that are located at a single training site, and simulates and records the demand and usage of resources at that particular site. To simulate a training system involving multiple sites, multiple computers are networked together. Synchronization of each site is maintained by a master system Controller. The Controller manages simulator initializations and message handling based on the specified rules of the network communication method described earlier.

Synchronization is a portion of the system that enables the distributed system to work correctly, since otherwise, the variations in speed between the various computers on the network would cause the different sites to diverge in simulation time. So a synchronization period is established, for instance at the end of a training week of simulated processing. At the start of the week, new students from another site are brought into the site/computer. Then the week of simulated training occurs, and any students that graduate or fail out of the courses are released into the network to go to their next course, reassigned course, or wastage point. There the student entity packet waits, until the beginning of the next week, when processing begins again. After each simulator finishes its week of processing, it stops and waits for the next Go signal. The Controller monitors all the computers for completion, then it transmits a Go message to all computers in the network, and they process another simulated week of training.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
establishing a plurality of training simulation sites;
coupling the sites together with a communications network;
transferring training related information via the network pertaining to progress of a student entity at a selected simulation site to a subsequent site at which the student entity is to train;
synchronizing the sites with a common indicator; and
responding to the common indicator by simulating an activity.

2. A method as in claim 1 which includes establishing interfaces at the respective simulation sites, the interfaces are responsive to a common protocol.

3. A method as in claim 1 where transferring includes transferring at least some of the training related information between sites using a predetermined format.

4. A method as in claim 1 when establishing includes selecting simulation sites from a class which includes aircraft simulators, watercraft simulators, and vehicular simulators.

5. A method as in claim 1 where coupling includes providing access to a multi-computer communications network; and where transferring includes transferring the training related information between sites, via the network,

6. A method as in claim 1 where synchronizing includes:
defining common timing cycles; and
where the common indicator includes sending a common start indicium to the sites to initiate a next time interval.

7. A method as in claim 1 which includes establishing a plurality of time intervals common to each of the sites.

8. A method as in claim 1 where the common indicator is coupled to the sites and initiates a next time interval for a respective simulated training activity.

9. A method as in claim 8 which includes generating a completion indicator at each of the simulation sites indicative that the respective site has completed simulation activity for a current time interval.

10. A method as in claim 9 which includes establishing that members of the plurality have each generated a respective completion indicator prior to issuing another common indicator to initiate a next time interval.

11. A method as in claim 1 where establishing includes establishing at each of some of the sites, a simulated training facility.

12. A method as in claim 11 where establishing includes, for each simulated training facility, establishing at least some of a plurality of flight simulators, a plurality of vehicular simulators, a plurality of watercraft simulators, a plurality of vehicles, a plurality of classrooms, a plurality of instructors, and a plurality of student entities.

13. A method as in claim 12 which includes transferring student entities between sites along with information pertaining to student entity status, courses to be taken and student entity prior simulated accomplishments.

14. A method as in claim 13 where the common indicator is coupled to the sites and initiates a next time interval for a respective simulated training activity.

15. A method as in claim 14 which includes generating a completion indicator at each of the simulation sites indicative that the respective site has completed simulation activity for a current time interval.

16. A method as in claim 15 which includes establishing that members of the plurality have each generated a respective completion indicator prior to issuing another common indicator to initiate a next time interval.

17. A simulation system comprising:
a plurality of simulators;
a control element;
a network that interconnects the members of the plurality with one another and with the control element where the control element transmits an interval start indicator to the members of the plurality to initiate simulation in accordance with a current simulation interval, and where the control element transmits a subsequent start indicator in response to all members of the plurality having issued an interval complete indicator.

18. A system as in claim 17 where each of the simulators comprises an activity training simulator.

19. A system as in claim 18 where the activities being simulated are selected from a class which includes operating a watercraft, operating an

20. A system as in claim 18 where members of the plurality transmit, via the network, update information to at least one other simulator for use in a next simulation interval.

21. A system as in claim 20 where each simulator receives all respective update information for use during the next simulation interval prior to initiating that simulation interval.

22. A system as in claim 20 where update information is multicast to other simulators.

23. A system as in claim 19 where the simulators each simulate training one or more simulated students in an activity selected from the class.

24. A system as in claim 23 where members of the plurality multicast student progress related information to other members for use in simulating subsequent training activities.

25. A system as in claim 24 where members of the plurality incorporate selected student progress related information, that resulted from a current simulation interval, into a simulation activity initiated by the subsequent start indicator.

26. A method comprising:
establishing a plurality of simulation sites;
establishing a simulation interval;
providing selected inputs to members of the plurality thereby establishing initial states at respective members of the plurality for a next simulation interval;
providing a common indicator which starts the simulation interval, the simulation interval becoming a current simulation interval;
simulating respective activities at members of the plurality for the current simulation interval in response to the common indicator;
generating a respective end indicator at members of the plurality in response to concluding all activities at the respective member for the current simulation interval
providing a common indicator which starts the next simulation interval, upon receipt of the end indicators from all the members of the plurality, the simulation interval becoming a current simulation interval.

27. A method as in claim 26 which includes determining that all members of the plurality have generated a respective end indictor before providing the common indicator which starts the next simulation interval.

28. A method as in claim 26 which includes transmitting update messages, originated during the current simulation interval, between sites prior to simulating respective activities during the next simulation interval.

29. A method as in claim 28 where transmitting update messages comprises multicasting the update messages.

30. A method as in claim 28 which includes providing a communications network that is coupled to members of the plurality.

31. A method as in claim 30 which includes multicasting the common indicator to members of the plurality.

32. A method as in claim 28 with each site having received all update messages prior to simulating respective activities for the next simulation interval.

33. A method as in claim 32 with each site having received all operational information for simulating respective activities during the next simulation interval prior to initiating simulation of those activities during that interval.

34. A method as in claim 26 where the sites each simulate a respective training activity.

35. A method as in claim 34 which includes transmitting update messages that pertain to progress of simulated students during the current simulation interval to other sites for subsequent simulation processing.
